(19) United States
(12) Patent Application Publication
(10) Pub. No.: US 2009/0152030 A1
(43) Pub. Date: Jun. 18, 2009

(54) Apparatus and Method for Electric Vehicle Utilizing Dissimilar Electric Motors

(76) Inventor: Dennis Palatov, Portland, OR (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/332,885

(22) Filed: Dec. 11, 2008

Related U.S. Application Data
(60) Provisional application No. 61/013,785, filed on Dec. 14, 2007.

(51) Int. Cl. B60W 10/08; H02P 5/00; B60W 20/00; H02P 3/14

(52) U.S. Cl. 180/65.285; 318/98; 318/376; 180/65.6; 180/65.275

(57) ABSTRACT

An Electric Vehicle is equipped with a plurality of Electric Motors, with at least one motor optimized for operation in one vehicle speed range and at least another motor optimized for operation in a different vehicle speed range. Under acceleration, at any instance in time a majority proportion of power is directed to the motor that is best optimized for the current vehicle speed. Under deceleration, at any instance in time a majority proportion of regenerative braking is drawn from the motor that is best optimized for the current vehicle speed. Motors may be mechanically coupled to the same driven axle or to different driven axles.

### RELATED PRIORITY APPLICATION

This application claims priority to Provisional Application No. 61/013,785, entitled “Apparatus and Method for Electric Vehicle Utilizing Dissimilar Electric Motors”, filed on Dec. 14, 2007.

### FIELD OF THE INVENTION

The present invention relates to electric vehicles and in particular to electric vehicles having a plurality of dissimilar electric motors.

### BACKGROUND OF THE INVENTION

Roadgoing Electric Vehicles are currently gaining in popularity, driven by the rising cost of fossil fuels and the need to reduce pollution. Until recently, Electric Vehicles have been used primarily in niche applications such as golf carts, small utility vehicles, lift trucks and the like. Such vehicles are typically limited in speed and therefore are well suited to the application of known Electric Motor technologies. However, the newly rising demand for highway legal Electric Vehicles requires a much wider speed range than what is readily achievable within a single Electric Motor design.

A wide variety of Electric Motor types are known in the art. They include brush-type DC, AC induction and several Permanent Magnet types. Regardless of type, all Electric Motors share the tradeoffs of torque versus maximum operating speed. An illustration of typical Electric Motor characteristics is provided in FIG. 1. A motor of a given power output can be readily configured to operate at high speeds of several thousand RPM but this comes at the expense of reduced torque at lower speeds; this characteristic is shown as high speed Motor in the illustration. Alternatively, a Motor can be configured for high torque in the low speed ranges but the inductance required to achieve this results in a rapid drop-off of current and therefore torque as speed rises, illustrated as low speed Motor in FIG. 1. This can be partially offset by raising the supply voltage but practical limits in terms of cost and safety are rapidly reached. Several techniques exist in the art which seek to extend the useful speed range of an Electric Motor.

One such technique, applicable primarily to AC and some Permanent Magnet Motors, is known as Field Weakening. It consists of manipulating the instantaneous electric field within a Motor to effectively reduce its inductance and therefore extend its useful speed range. While generally effective, this technique still does not result in a motor that is useful over the entire speed range that is desirable for a highway legal vehicle. Also, Field Weakening is not applicable to some motor types.

Another technique used to extend useful speed range is series-parallel switching. To accomplish this, two motors are employed, usually coupled to a common output shaft. At low speeds the motors are connected in series to produce maximum torque. As speed rises, a contactor is switched to effect a parallel connection of the two motors. This cuts the effective inductance of the combined powerplant in half, allowing extended speed range at a reduced overall torque. This technique is quite effective for brush-type DC Motors since only two current paths need to be switched and the overall circuit remains relatively simple and robust. The technique is much more difficult to apply to 3-phase AC driven motor types due to complexity in wiring and the need for very precise synchronization and alignment of the two motors.

A third commonly used technique employs a mechanical transmission where two or more gear ratios may be selected, similar to the transmissions commonly used for internal combustion powertrains. While effective, this technique considerably increases the complexity, weight and maintenance requirements of a vehicle's powertrain. Additionally, efficiency is reduced due to gear transmission losses.

Recent developments in Motor design and controller electronics, such as the Axial Flux Permanent Magnet Motors developed by Apex Labs, enable the efficient direct coupling of a motor to a driven wheel, without the use of gear reduction units or differentials. However, even employing techniques such as field weakening, the effective speed range of such motors is inadequate to cover the desired speed range of a highway legal vehicle.

What is needed is an Electric Vehicle powertrain that would take advantage of the efficiencies arising from the use of Electric Motors while allowing a full highway legal speed range to be achieved.

### SUMMARY OF THE INVENTION

A primary objective of an embodiment of the present invention is to enable the efficient use of Electric Motors to propel an Electric Vehicle at a wide range of speeds without the need for shifting gears or reconfiguring high-current wiring topology.

### BRIEF DESCRIPTION OF THE DRAWINGS

The present invention is described herein with reference to the following drawings:

FIG. 1 illustrates the torque curves of typical Electric Motors;

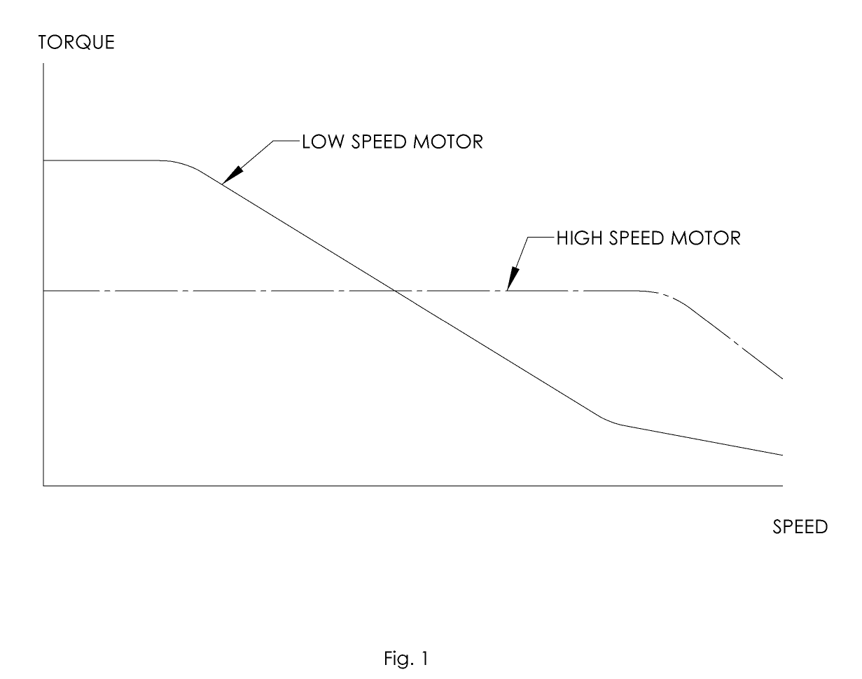

FIG. 2 shows an Electric Vehicle according to one embodiment of the present invention utilizing four direct-coupled Motors;

FIG. 3 shows an Electric Vehicle according to one embodiment of the present invention utilizing Hub Motors;

FIG. 4 shows an Electric Vehicle according to one embodiment of the present invention with two Motors coupled to a gear reduction unit and differential; and

FIG. 5 is a diagram illustrating a method according to an embodiment of the present invention

### DETAILED DESCRIPTION OF THE EMBODIMENTS OF THE INVENTION

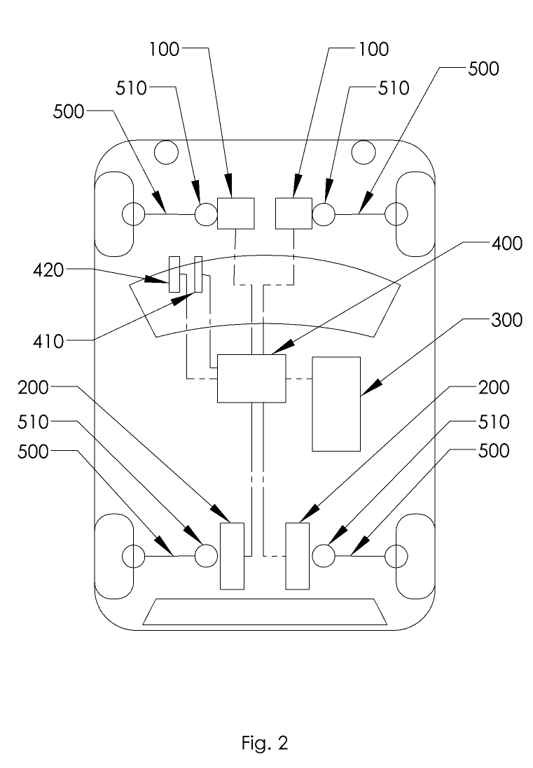

A number of different embodiments of the present invention are possible. A first embodiment, illustrated in FIG. 2, is an Electric Vehicle having four Electric Motors, with each Electric Motor being directly coupled to a single driven wheel by means of a driveshaft. In this embodiment two high speed Electric Motors 100 are located at the front axle of the vehicle, each Motor being directly coupled to a front wheel by means of a driveshaft 500 equipped with CV joints 510. Two low-speed Electric Motors 200 are located at the rear axle of the vehicle, each Motor being coupled to a rear wheel by means of a driveshaft 500. Any of the Motor types known in the art may be used, including DC and AC types and their variants. In some cases, it may be advantageous to have the high speed Electric Motors 100 be of different type than the low speed Electric Motors 200 in order to best optimize them for their respective speed ranges. In other embodiments, it may be advantageous to have high speed Electric Motors be substantially identical to low speed Electric Motors and to optimize each motor for its intended operating speed range by use of a different gear ratio in the mechanical coupling of the motors to the driven axle. In most practical implementations, it is advantageous to have the top of the high speed Motor range extend to approximately twice the top end of the low speed Motor range.

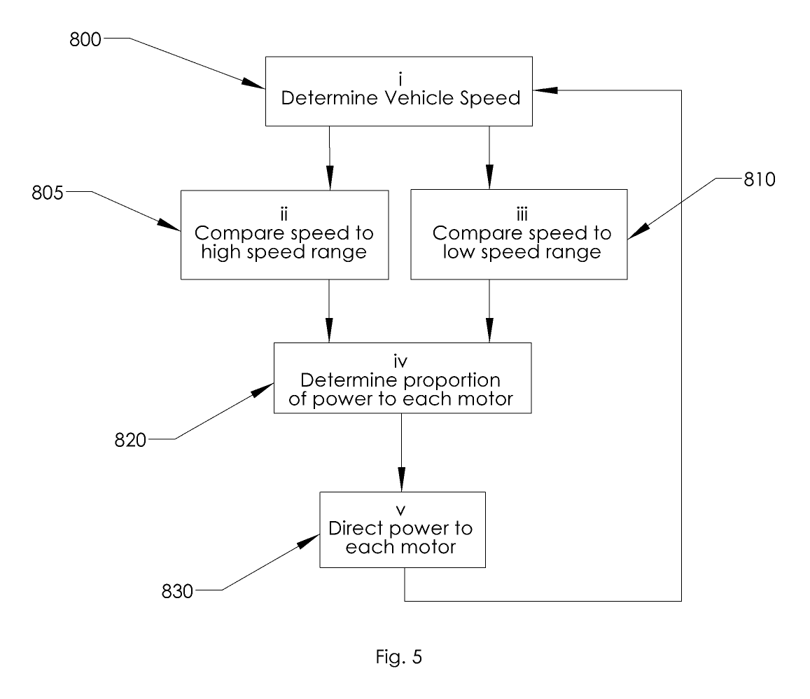

The vehicle is further equipped with a battery pack 300 and a motor controller 400. The motor controller receives driver input by means of throttle pedal 410 and brake pedal 420 and controls each of the high speed Electric Motors 100 and each of the low speed Electric Motors 200 in accordance with the inputs and the Method of the present invention. Specifically, with reference to FIG. 5, at predetermined intervals which are preferably several milliseconds, the motor controller evaluates at 800 the current vehicle speed, which is directly related to the current rotational speed of each Motor, and the signals from user inputs. Under the Method of the present invention and distinct from other methods known in the art, the current speed of each Motor is compared to the predetermined optimum operating speed range for each Motor at 805 and 810. As a result of this comparison, at 820 in an accelerative condition a determination is made as to what proportion of total drive current should be delivered to each Motor in order to achieve best efficiency at this instantaneous condition. Alternatively, at 820, in a decelerative condition, a similar determination is made as to what proportion of regenerative braking current should be drawn from each Motor. The exact algorithms used for determining specific proportions of current and power applied to each motor will vary with vehicle design and shall be readily apparent to those skilled in the art. The innovation of the Method of the present invention lies in the steps of making the comparison of current vehicle speed to each Motor's optimum speed range and subsequently proportioning Motor power based on this comparison, and not in the specific algorithms used to perform the comparison and the proportioning.

Once the proportioning determination is made, it is translated at 830 into a specific drive command to the electronics controlling each motor in any manner known in the art to direct power to each motor. Typically, a software algorithm is applied based on the specific drive command to determine the flow of current to and from each of the motors. A wide variety of motor controller designs and motor control algorithms are known in the art, including those employing Field Weakening to extend each Motor's useful speed range, and therefore they are not discussed in detail herein.

Under acceleration from standstill and low speeds, the attendant rearward weight transfer makes it more efficient to direct most of the drive power to the rear wheels. The weight transfer increases traction at the rear wheels and decreases it at the front. As vehicle speed increases, the acceleration diminishes and with it so does weight transfer. At higher speeds it becomes advantageous to direct more drive to the front wheels to enhance stability. Under braking from high speeds, the forward weight transfer increases the front traction and therefore makes it advantageous to perform the majority of the braking at the front wheels. At lower speeds deceleration is typically reduced and therefore the rear wheels can do more of the braking without lockup. For these reasons the high speed Motors of this embodiment are coupled to the front wheels and the low speed Motors are coupled to the rear wheels, in order to best match the Motor operating range to the operating conditions at each axle.

A variation of the first embodiment may employ only one Motor at either or both axles, the Motor being mechanically coupled to both wheels of the axle by means of a differential and two driveshafts.

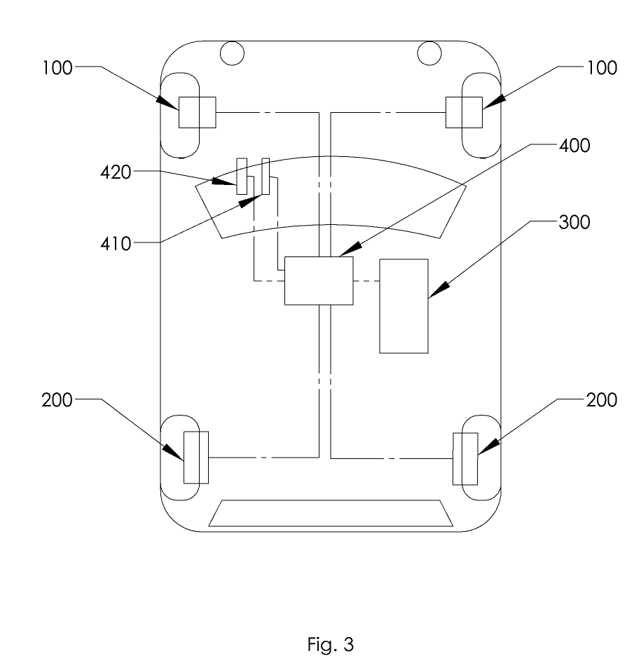

A second embodiment is similar to the one described above, but with the Motors 100 and 200 located directly at the wheels instead of using driveshafts to couple the Motors to the wheels. Such a configuration is known in the art as hub motor and is illustrated in FIG. 3. Aside from this mechanical layout difference, the second embodiment is identical to the first in principles and Method of operation.

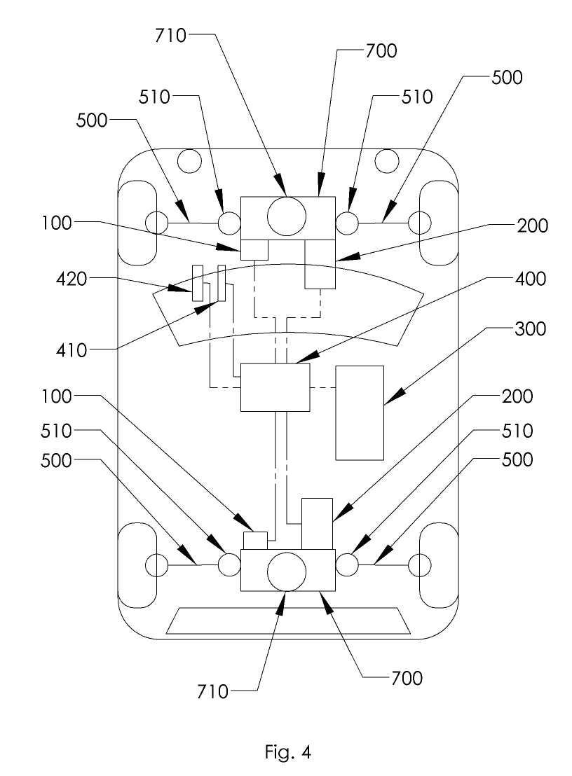

A third embodiment utilizes a high speed Motor 100 and a low speed Motor 200, both coupled by means of a gear reduction unit 700 to a differential 710. Variations of this embodiment are possible where the high and low speed motors are physically different and employ substantially similar ratios in the gear reduction unit 700, or alternatively wherein the two motors are substantially identical and are coupled to the differential 710 by means of distinct and different gear ratios within the gear reduction unit 700. Driveshafts 500 are used to couple the differential to the driven wheels. Front, rear or both axles may be driven. In the latter case, two motors coupled to a differential are used at each axle as illustrated in FIG. 4.

In all the embodiments disclosed above, any Electric Motor type can be utilized for high speed and low speed motors and the two may be of different types. For example, the gear reduction unit of the third embodiment generally favors the use of higher-speed AC motors while the direct coupling of the first and second embodiments generally favors high-torque, multi-pole Motor types. Many different combinations of known Motor types and the known means of mechanically coupling the Motors to driven wheels are possible within the scope of the present invention. Further, known range-extending techniques such as those discussed earlier herein may be used in combination with the teaching of the present invention without departing from its scope.

The embodiments disclosed herein are illustrative and not limiting. Many other designs shall become apparent to those skilled in the art that can be practiced without departing from the teaching of the present invention.

Within the scope of the present invention, an Electric Vehicle is a vehicle having Electric Motors mechanically coupled to at least one driven axle. An Electric Vehicle of the present invention may also have an internal combustion engine operating in series or in parallel with Electric Motors. Such vehicles are typically referred to as hybrids. Because the principles of the present invention apply to operating Electric Motors irrespective of whether an internal combustion engine is also present, a hybrid vehicle having Electric Motors is to be considered an Electric Vehicle within the scope of the present invention.

What is claimed is:

1. An Electric Vehicle comprising: a plurality of Electric Motors, each said motor being mechanically coupled to at least a driven axle, and wherein at least a first Electric Motor is configured to optimally operate in a first vehicle speed range; and at least a second Electric Motor is configured to optimally operate in a second vehicle speed range; said second vehicle speed range being at least in part different from said first vehicle speed range.

2. The Electric Vehicle of claim 1 wherein said configuration of an Electric Motor for operation in a vehicle speed range is accomplished by means of a gear ratio; and wherein said first Electric Motor is mechanically coupled to a driven axle by means of a gear ratio distinct from that of coupling of said second Electric Motor.

3. The Electric Vehicle of claim 1 wherein said first Electric Motor is of different type than said second Electric Motor.

4. The Electric Vehicle of claim 1 wherein said first Electric Motor is mechanically coupled to a driven axle and said second Electric Motor is mechanically coupled to the same driven axle.

5. The Electric Vehicle of claim 4 wherein said first Electric Motor is mechanically coupled to a driven axle by means of a gear ratio different from that of said second Electric Motor.

6. The Electric Vehicle of claim 1 wherein said first Electric Motor is mechanically coupled to a first driven axle and said second Electric Motor is mechanically coupled to a second driven axle, distinct from the first driven axle.

7. The Electric Vehicle of claim 6 wherein said mechanical coupling of an Electric Motor to a driven axle is accomplished without utilizing a gear reduction unit.

8. The Electric Vehicle of claim 1 wherein the upper speed of said second vehicle speed range is approximately double the upper speed of said first vehicle speed range.

9. The Electric Vehicle of claim 1 wherein said first Electric Motor is mechanically coupled to a rear driven axle and said second Electric Motor is mechanically coupled to a front driven axle; said second Electric Motor having an operating vehicle speed range greater than said first Electric Motor.

10. A method of accelerating an Electric Vehicle, said Electric Vehicle having a plurality of Electric Motors, wherein at least a first Electric Motor is configured to optimally operate in a first speed range, and at least a second Electric Motor is configured to optimally operate in a second speed range, said second speed range being substantially different from said first speed range, said method comprising:
i detecting the current vehicle speed;
ii determining whether the current vehicle speed falls into said first speed range;
iii determining whether the current vehicle speed falls into said second speed range;
iv based on the determinations, determining a first proportion of available power to be directed to said first Electric Motor and a second proportion of available power to be directed to said second Electric Motor; and
v directing the first proportion of available power to said first Electric Motor and directing the second proportion of available power to said second Electric Motor.

11. A method of decelerating an Electric Vehicle by means of regenerative braking, said Electric Vehicle having a plurality of Electric Motors, wherein at least a first Electric Motor is configured to optimally operate in a first speed range, and at least a second Electric Motor is configured to optimally operate in a second speed range, said second speed range being substantially different from said first speed range, said method comprising:
i detecting the current vehicle speed;
ii determining whether current vehicle speed falls into said first speed range;
iii determining whether current vehicle speed falls into said second speed range;
iv based the determinations, determining what proportion of regenerative current derived from braking is to come from said first Electric Motor and what proportion of regenerative current derived from braking is to come from said second Electric Motor; and
v drawing the proportion of regenerative current from said first Electric Motor and drawing the proportion of regenerative current from said second Electric Motor.
